(19) United States
(12) Patent Application Publication
(10) Pub. No.: US 2005/0190895 A1
(43) Pub. Date: Sep. 1, 2005

(54) Remotely programmable messaging apparatus and method thereof

(76) Inventors: Lloyd Ploof, Ilion, NY (US); Lon S. Thrasher JR., New York Mills, NY (US); Matthew J. Sisti, Marcy, NY (US)

Correspondence Address: ARLEN L. OLSEN;SCHMEISER, OLSEN & WATTS, 3 LEAR JET LANE, SUITE 201, LATHAM, NY, 12110, US

(21) Appl. No.: 10/790,172

(22) Filed: Mar. 1, 2004

(51) Int. Cl. H04M 11/00; H04M 1/64

(52) U.S. Cl. 379/88.16

(57) ABSTRACT

A remotely programmable messaging apparatus for displaying a message in a vehicle and method of displaying the message in the vehicle. The messaging apparatus includes a First Auto-Message or First Instant Message that may be included in a source device, wherein the source device includes a source antenna, a source microprocessor, a locator, such as a GPS, and a source display device. In addition, the messaging apparatus may include a Second Auto-Message or Second Instant Message in a mailbox that may be displayed on the source display device. The vehicle may be any vehicle used for transportation of people, such as automobiles, busses, trains or trucks, who may benefit from receiving information such as the First Auto-Message or First Instant Message and the Second Auto-Message or Second Instant Message.

### BACKGROUND OF THE INVENTION

1. Technical Field

The present invention relates generally to electronic devices for messaging and methods of using thereof, and more particularly, devices for Auto-Messaging or Instant Messaging using radio, television or hand-held microprocessors in moving vehicles such as automobiles and methods of using thereof.

2. Related Art

Electronic media have been used to display time delayed text or pictorial message on faces of buildings to advertise, on livery vehicles to indicate availability for occupancy, or on passenger busses to indicate destination. Such text or pictorial messages traditionally originate locally such as from a dedicated personal computer, microprocessor or other appropriate electronic storage medium.

There is a need for electronic media that can display instant text or pictorial messages that may display text or pictorial messages in real time.

### SUMMARY OF THE INVENTION

A first embodiment of the present invention is a messaging system, comprising: a First Auto-Message or First Instant Message; and a mailbox in a mailbox vehicle, wherein the mailbox includes a mailbox microprocessor and a mailbox visual display device, and wherein the First Auto-Message or First Instant Message is displayed on the mailbox visual display device.

A second embodiment of the present invention is a messaging system, comprising: a First Auto-Message or First Instant Message; a mailbox in a mailbox vehicle, wherein the mailbox includes a mailbox microprocessor and a mailbox visual display device, and wherein the First Auto-Message or First Instant Message is displayed on the mailbox visual display device, wherein the First Auto-Message or First Instant Message may be included in the a source device, and wherein the source device includes a source antenna, a source microprocessor, a locator, such as a Geographical Positioning System, (GPS) and a source display device. In addition, the mailbox may include a Second Auto-Message or Second Instant Message that may be displayed on the source display device.

A third embodiment of the present invention is a method of displaying information from at least one vehicle, comprising: providing at least one source device in at least one source vehicle, wherein the at least one source device includes a First Auto-Message or First Instant Message; and providing at least one mailbox in at least one mailbox vehicle, wherein the at least one mailbox includes a mailbox display device, and wherein the at least one mailbox receives the First Auto-Message or First Instant Message; and displaying the First Auto-Message or First Instant Message on the mailbox display device.

A fourth embodiment of the present invention is a method of displaying information from at least one vehicle, comprising: providing at least one source device in at least one source vehicle, wherein the at least one source device includes a First Auto-Message or First Instant Message; providing at least one mailbox in at least one mailbox vehicle, wherein the at least one mailbox includes a mailbox display device, and wherein the at least one mailbox receives the First Auto-Message or First Instant Message; displaying the First Auto-Message or First Instant Message on the mailbox display device; providing a Second Auto-Message or Second Instant Message in the at least one mailbox: and providing a source display device in the source device and displaying the Second Auto-Message or Second Instant Message on the source display device.

### BRIEF DESCRIPTION OF THE DRAWINGS

FIG. 1 depicts a messaging system, in accordance with embodiments of the present invention;

FIG. 2 depicts FIG. 1, wherein the first Auto-Message or first Instant Message is included in a source device;

FIG. 3 depicts of displaying information from at least one vehicle, in accordance with embodiments of the present invention; and

FIG. 4 depicts an automobile, having a First Auto-Message or First Instant Message, or a Second Auto-Message or Second Instant Message, in accordance with embodiments of the present invention.

### DETAILED DESCRIPTION OF THE INVENTION

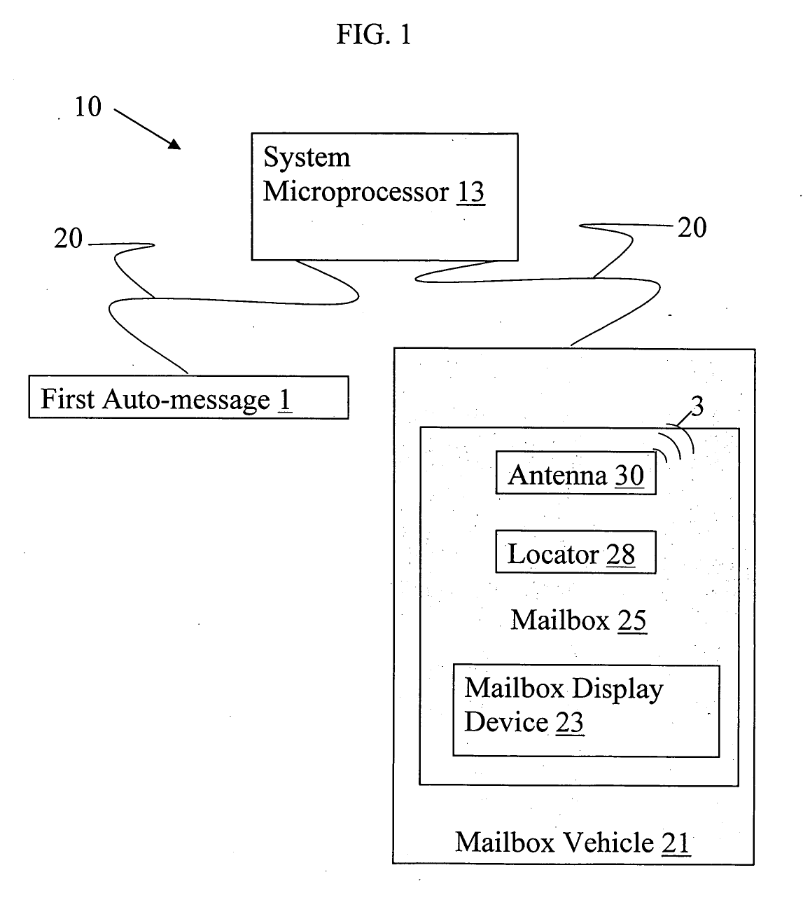

FIG. 1 depicts a messaging system 10, comprising: a First Auto-Message or First Instant Message 1; an optional system microprocessor 13, and a mailbox 25 in a mailbox vehicle 21, wherein the mailbox 25 includes a mailbox display device 23, and wherein the First Auto-Message or First Instant Message 1 is displayed on the mailbox display device 23. The mailbox vehicle 21 may be any vehicle used for transportation of people, such as automobiles, busses, trains or trucks, who may benefit from receiving information such as the first Auto-Message or first Instant Message 1. The mailbox vehicle 21 may be moving, such as along a highway, road, or turnpike, or the mailbox vehicle 21 may be stationary, such as when parked in a parking lot.

The First Auto-Message or First Instant Message 1 may be verbal, spoken into a telephone, a radio transmitter, a hand held microprocessor or a microphone. The First Auto-Message or First Instant Message 1 may be generated automatically by the optional system microprocessor 13 that may include software for generating the Message 1 at a desired time or interval. Alternatively, the optional system microprocessor 13 may include voice recognition software to enable conversion of the verbal message 1 into computer readable code. The First Auto-Message or First Instant Message may be transmitted as an electromagnetic signal that is conveyed by the messaging system 10 to be displayed by the mailbox display device 23 at the speed of light, and as such, be an instant message. The First Auto-Message or First Instant Message 1 may include region specific information selected from the group of specific information consisting of nearest grocery stores, emergency services, restaurants, entertainment providers and combinations thereof. The First Auto-Message or First Instant Message 1 may alternatively be input to the mailbox microprocessor 13 from a keyboard or keypad. Alternatively, the First Auto-Message or First Instant Message 1 may be instant news. Alternatively, the First Auto-Message or First Instant Message 1 may be selected from the group consisting of personalized messages, advertising, accident notification, weather conditions, hazards and combinations thereof.

The mailbox display device 23 may be a light emitting diode array (LED), a thin film transparency, a cathode ray tube, a liquid crystal display, a projected image or message, or a television. The mailbox display device 23 may be located in a vehicle window, a radio console, and a vehicle console, or anywhere on the vehicle.

The mailbox 25 may optionally include a locator 28, such as a geographical positioning system (GPS) and an antenna 30 that may receive telecommunications 3 such as radio, television microwave. Alternatively, the mailbox 25 may be adapted to receive telecommunications 20 from, for example, wire-line phone companies, the internet or alternative broad band telecommunication services, or satellite.

With voice over Internet protocol, or VoIP, Companies may provide their customers with specialized computer equipment that converts voice signals such as First Auto-Message or First Instant Message 1 into digital information packets and sends them over the Internet. The service may use a broadband Internet connection and can reconfigure the packets to terminate on the regular phone network.

A central issue posed by VoIP is whether, under the statutory definitions adopted by the Telecommunications Act of 1996, VoIP should be treated as a “telecommunications service,” with the regulatory obligations that classification implies, or whether VoIP should be treated as an “information service,” that is not subject to Title regulation. In the Telecommunications Act of 1996, Congress enunciated a clear national policy to “make advanced telecommunications and information services available to all Americans” by opening all telecommunications markets to competition and deregulation. While introducing a complicated plan to phase out regulation among wire-line phone companies, the 1996 act clearly stated that “information services” such as the Internet should be allowed to flourish “unfettered by federal or state regulation.”

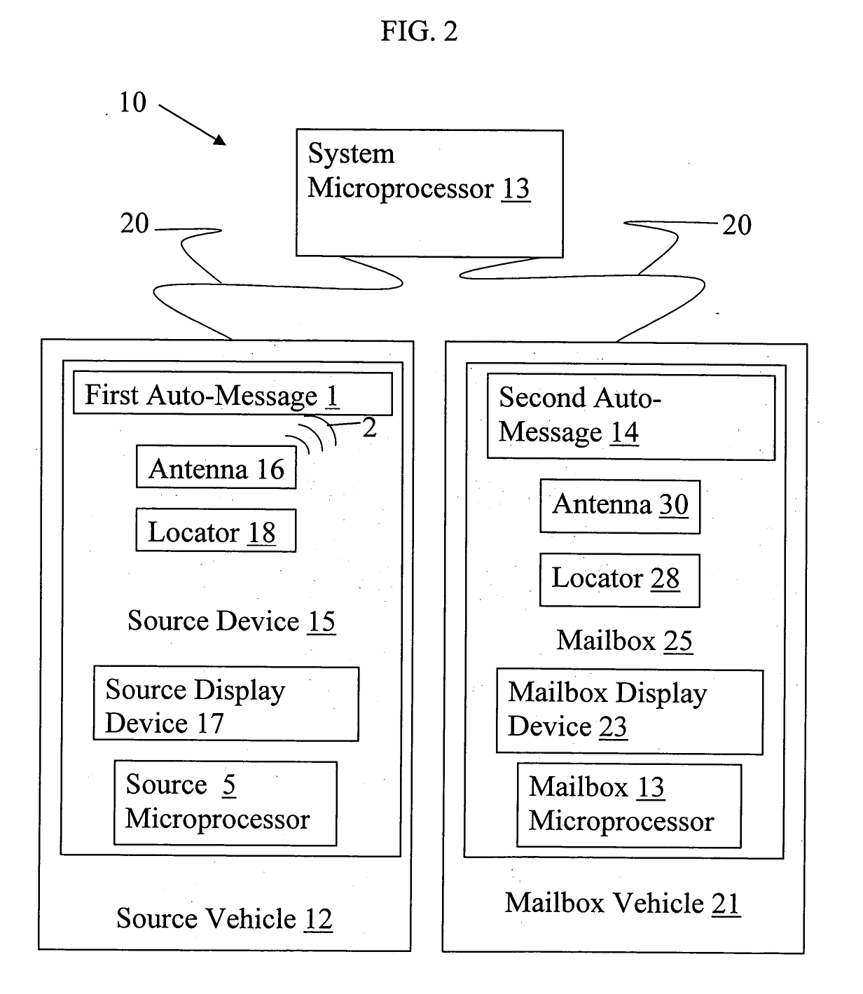

FIG. 2 depicts the messaging system 10 of FIG. 1, wherein the First Auto-Message or First Instant Message 1 may be included in a source device 15, and wherein the source device 15 includes a source antenna, 16, a source microprocessor 5, a locator, 18, such as a GPS, and a source display device 17. In addition, the mailbox 25 may include a Second Auto-Message or Second Instant Message 14 that may be displayed on the source display device 17. The source vehicle 12 may be any vehicle used for transportation of people, such as automobiles, busses, trains or trucks, who may benefit from receiving information such as the Second Auto-Message or Second Instant Message 14. The source vehicle 12 may be moving, such as along a highway, road, or turnpike, or the source vehicle 12 may be stationary, such as when parked in a parking lot. The Second Auto-Message or Second Instant Message 14 may be verbal, spoken into a telephone, a radio transmitter, a hand held microprocessor or a microphone. The Second Auto-Message or Second Instant Message 14 may be generated automatically by the optional system microprocessor 13 that may include software for generating the Message 14 at a desired time or interval. Alternatively, the optional system microprocessor 13 may include voice recognition software to enable conversion of the verbal message 14 into computer readable code. The Second Auto-Message or Second Instant Message may be transmitted as an electromagnetic signal that is conveyed by the messaging system 10 to be displayed by the mailbox display device 23 at the speed of light, and as such, be an instant message. The Second Auto-Message or Second Instant Message 14 may include region specific information selected from the group of specific information consisting of nearest grocery stores, emergency services, restaurants, entertainment providers and combinations thereof. The Second Auto-Message or Second Instant Message 14 may alternatively be input to the source microprocessor 5 from a keyboard or keypad. Alternatively, the Second Auto-Message or Second Instant Message 14 may be instant news. Alternatively, the Second Auto-Message or Second Instant Message 14 may be selected from the group consisting of personalized messages, advertising, accident notification, weather conditions, hazards and combinations thereof.

The source display device 17 may be a light emitting diode array (LED), a thin film transparency, a cathode ray tube, a liquid crystal display, or a television, or projected image or message. The source display device 17 may be located in a car window, a radio console, and a car console.

The source device 15 may optionally include a locator 18, such as a geographical positioning system (GPS) and an antenna 16, that may receive telecommunications 2 such as radio, television microwave. Alternatively, the source device 15 may be adapted to receive telecommunications 20 from, for example, wire-line phone companies, the internet or alternative broad band telecommunication services, or satellite.

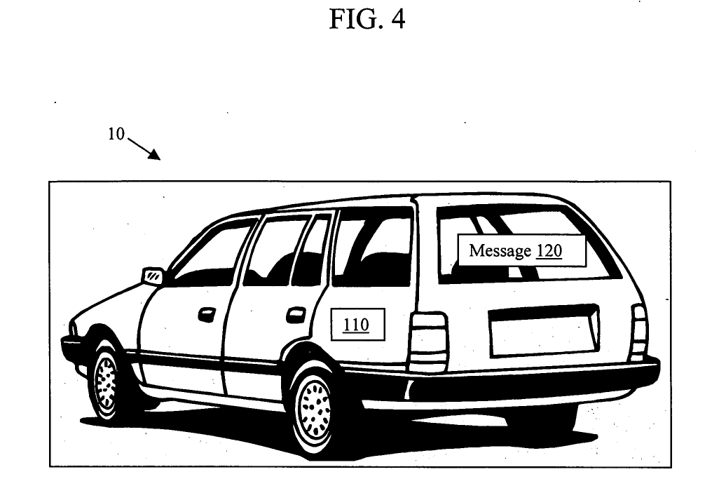

Referring to FIGS. 1 and 2, the at least one source vehicle 12 or the at least one mailbox vehicle 21 may be an automobile 110, having a First Auto-Message or First Instant Message 1, or a Second Auto-Message or Second Instant Message 14 such as the message 120 as depicted in FIG. 4.

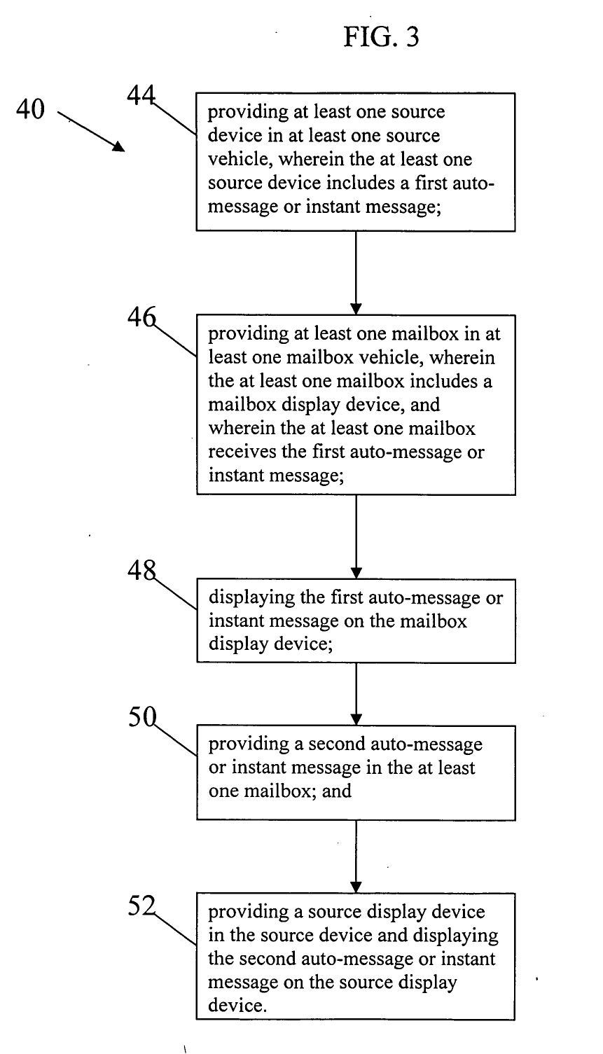

Referring to FIGS. 1 and 2, FIG. 3 depicts a method 40 of displaying information from at least one source vehicle 12, or at least one mailbox vehicle 21, comprising: a step 44, providing at least one source device 15 in at least one source vehicle 12, wherein the at least one source device 15 includes a First Auto-Message or First Instant Message 1; a step 46, providing at least one mailbox 25 in at least one mailbox vehicle 21, wherein the at least one mailbox 25 includes a mailbox display device 23, and wherein the at least one mailbox 25 receives the First Auto-Message or First Instant Message 1; a step 48, displaying the First Auto-Message or First Instant Message 1 on the mailbox display device 23; a step 50, providing a Second Auto-Message or Second Instant Message 14 in the at least one mailbox 25; and a step 52, providing a source display device 17 in the source device 15 and displaying the Second Auto-Message or Second Instant Message 14 on the source display device 15.

The source vehicle 12 may travel alongside the mailbox vehicle 21 when the First Auto-Message or First Instant Message 1 or the Second Auto-Message or the Second Instant Message 14 is a personalized message, that includes, for example, individual specific information such as a greeting or salutation to a friend or stranger in either the source vehicle 12 or the mailbox vehicle 21, or region specific information selected from the group of specific information consisting of nearest grocery stores, emergency services, restaurants, entertainment providers and combinations thereof. The greeting may be “Hi, meet you at the next rest area,” “Cell Phone Number?,” or “Do you want to have coffee?”

Alternatively, the at least one source vehicle 12 and the at least one mailbox vehicle 21 may not be visible to passengers inside the at least one source vehicle 12 and the at least one mailbox vehicle 21 when the First Auto-Message or First Instant Message 1, or the Second Auto-Message or the Second Instant Message 14 is a personalized message, that includes, for example, individual specific information such as a greeting or salutation to a friend or stranger in either the source vehicle 12 or the mailbox vehicle 21, or region specific information selected from the group of specific information consisting of nearest grocery stores, emergency services, restaurants, entertainment providers and combinations thereof. The greeting may be “Hi, meet you at the next rest area,” “What is your cell phone number?,” “Do you want to have coffee,” and combinations thereof, because the at least one source vehicle 12 and the at least one mailbox vehicle 21 may be separated by a distance ranging from about 10 feet to about 3,000 miles. In one embodiment, when the at least one source vehicle 12 and the at least one mailbox vehicle 21 are not visible to passengers inside the vehicles 12 and 21, a distance separating the at least one source vehicle 12 and the at least one mailbox vehicle 21 may be preferably from about 10 feet to about 1,000 miles, more preferably from about 10 feet to about 100 miles and most preferably from about 10 feet to about 10.0 miles.

Alternatively, the at least one source vehicle 12 and the at least one mailbox vehicle 21 may not be visible to passengers inside the at least one source vehicle 12 and the at least one mailbox vehicle 21 when the First Auto-Message or First Instant Message 1, or the Second Auto-Message or the Second Instant Message includes, for example, individual specific information such as advertising, accident notification, weather conditions, hazards and combinations thereof, because the at least one source vehicle 12 and the at least one mailbox vehicle 21 may be separated by a distance ranging from about 10 feet to about 3,000 miles. In one embodiment, when the at least one source vehicle 12 and the at least one mailbox vehicle 21 are not visible to passengers inside the vehicles 12 and 21, a distance separating the at least one source vehicle 12 and the at least one mailbox vehicle 21 may be preferably from about 10 feet to about 1,000 miles, more preferably from about 10 feet to about 100 miles and most preferably from about 10 feet to about 10.0 miles.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A messaging system, comprising:
a First Auto-Message or First Instant Message; and
a mailbox in a mailbox vehicle, wherein the mailbox includes a mailbox microprocessor and a mailbox visual display device, and wherein the First Auto-Message or First Instant Message is displayed on the mailbox visual display device.

2. The system of claim 1, wherein the First Auto-Message or First Instant Message is verbal.

3. The system of claim 2, wherein the verbal First Auto-Message or First Instant Message is recognized by the system using voice recognition software.

4. The system of claim 2, wherein the verbal First Auto-Message or First Instant Message is spoken into a telephone, a radio transmitter, a hand held microprocessor or a microphone.

5. The system of claim 1, wherein the display device is a Light Emitting Diode Array, a thin film transparency, a cathode ray tube, a liquid crystal display, or a television, or projected image or message.

6. The system of claim 1, wherein the First Auto-Message or First Instant Message includes region specific information selected from the group of specific information consisting of nearest grocery stores, emergency services, restaurants, entertainment providers and combinations thereof.

7. The system of claim 1, wherein the First Auto-Message or First Instant Message is input to the mailbox microprocessor from a keyboard or keypad.

8. The system of claim 1, wherein the First Auto-Message or First Instant Message is instant news.

9. The system of claim 1, wherein the First Auto-Message or First Instant Message is selected from the group consisting of personalized messages, advertising, accident notification, weather conditions, hazards and combinations thereof.

10. The system of claim 1, wherein a location of the display device is selected from the group consisting of a car window, a radio console, and a car console.

11. The system of claim 1, wherein the mailbox has a locator.

12. The system of claim 1, wherein the locator is a GPS.

13. The system of claim 1, further comprising a source device, wherein the First Auto-Message or First Instant Message is included in the source device, wherein the source device includes a source microprocessor and a source display device, and wherein the mailbox generates a Second Auto-Message or Second Instant Message that is displayed on the source display device.

14. The system of claim 13, wherein the source device is in a source vehicle.

15. The system of claim 12, wherein the source vehicle and the mailbox vehicle each have a locator.

16. The system of claim 13, wherein the second Auto-Message or second Instant Message is selected from the group consisting of personalized messages, advertising, accident notification, weather conditions, hazards and combinations thereof.

17. The system of claim 13, wherein the second Auto-Message or second Instant Message is instant news.

18. The system of claim 13, wherein the second Auto-Message or second Instant Message is input to the source microprocessor from a keyboard or keypad.

19. The system of claim 13, wherein the second Auto-Message or second Instant Message includes region specific information selected from the group of specific information consisting of nearest grocery stores, emergency services, restaurants, entertainment providers and combinations thereof.

20. A method of displaying information from at least one vehicle, comprising:
providing at least one source device in at least one source vehicle, wherein the at least one source device includes a First Auto-Message or First Instant Message; and
providing at least one mailbox in at least one mailbox vehicle, wherein the at least one mailbox includes a mailbox display device, and wherein the at least one mailbox receives the First Auto-Message or First Instant Message; and
displaying the First Auto-Message or First Instant Message on the mailbox display device.

21. The method of claim 20, further comprising:
providing a Second Auto-Message or Second Instant Message in the at least one mailbox: and
providing a source display device in the source device and displaying the Second Auto-Message or Second Instant Message on the source display device.

22. The method of claim 20, wherein the First and Second Auto-Message or First and Second Instant Message include region specific information selected from the group of specific information consisting of nearest grocery stores, emergency services, restaurants, entertainment providers and combinations thereof.
